(19) United States
(12) Patent Application Publication
(10) Pub. No.: US 2011/0073098 A1
(43) Pub. Date: Mar. 31, 2011

(54) MULTI-FUNCTIONAL COOKING STOVE

(75) Inventor: FREDDIE CHANG, Arcadia, CA (US)

(73) Assignee: aFIRE INC., Evanston, IL (US)

(21) Appl. No.: 12/699,061

(22) Filed: Feb. 3, 2010

(30) Foreign Application Priority Data
Sep. 25, 2009 (TW) 098217788

(51) Int. Cl. A47J 37/00

(52) U.S. Cl. 126/25 B

(57) ABSTRACT

A multi-functional cooking stove of the present invention includes a stove body, a position frame and a stove element. The stove body has an annular shell which defines an upper opening and a lower opening. The lower opening is smaller than the upper one. The position frame is disposed in the stove body and defines a through hole at its center for a container body of the stove element to pass therethrough. The stove element is adapted for fuel to dispose therein. A convection space is defined between the stove body and the stove element. At least one convection bore is formed on a periphery of the container body to communicate the convection space with an interior of the container body.

### BACKGROUND OF THE INVENTION

1. Field of the Invention

The present invention relates to a cooking stove, and more particularly to a multi-functional cooking stove suitable for many cooking manners.

2. Description of the Prior Art

Barbecue is popular around the world, especially in reunions or outings with family or friends. People can have fun broiling food manually and interacting with each other at the same time.

The conventional cooking stoves, such as the Applicant's TW pat. No. M327704 and M340020, mainly include an annular web partition disposed at the center of the stove and a grill disposed atop the web partition. The Fuel such as charcoal is displaced between the web partition and the stove shell, preventing the grease and barbecue sauce from directly dripping on the charcoal and causing hazard or smoke.

Such conventional cooking stoves are not direct-heating type stove, i.e. the heat source is not located right beneath the food, but they mainly use the heated air flow generated by the lateral heating source to heat the food, and more particularly to broil the food.

To make a cooking stove using solid fuel more functional, it is necessary to refine the stove structure to center the heat energy for the cooking stove to be adapted for different cooking manners such as frying, boiling, stewing, sauteing, hot-potting, broiling and roasting, which is the main goal of the Applicant.

### SUMMARY OF THE INVENTION

The main object of the present invention is to provide a cooking stove adapted for many cooking manners.

Another main object of the present invention is to provide a cooking stove that centers the heat energy efficiently.

Yet another main object of the present invention is to provide a cooking stove that is easy to catch fire.

To achieve the above and other objects, a cooking stove of the present invention includes a stove body, a position frame and a stove element. The stove body has an annular shell which defines an upper opening and a lower opening, and the lower opening is smaller than the upper opening. The position frame is disposed in the stove body and defines a through hole at its center. The stove element has a container body for fuel to dispose therein. The container body passes through the through hole, and the stove element is hung on the position frame. A convection space is defined between the stove body and the stove element. At least one convection bore is disposed on a periphery of the container body. The convection bore communicates the convection space with an interior of the container body.

Thereby, the cooking stove can center the heat energy and be adapted for cooking manners such as frying, boiling, stewing, sauteing, hot-potting, broiling and roasting. In addition, the stove element can be taken out of the stove body for the user to easily catch fire. Thereafter, the user can transport the stove element with the help of the position frame and then place the stove element and the position frame in the stove body.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a breakdown drawing showing a first preferred embodiment of the present invention;

FIG. 2 is a combination drawing showing a first preferred embodiment of the present invention;

FIG. 3 is a profile showing a first preferred embodiment of the present invention;

FIG. 4 is a profile showing the operation state of a first preferred embodiment of the present invention;

FIG. 5 is a partial breakdown drawing showing a second preferred embodiment of the present invention;

FIG. 6 is a combination drawing showing a second preferred embodiment of the present invention;

FIG. 7 is a partial breakdown drawing showing a third preferred embodiment of the present invention;

FIG. 8 is a profile showing the operation state of a third preferred embodiment of the present invention;

FIG. 9 is a partial breakdown drawing showing a fourth preferred embodiment of the present invention;

FIG. 10 is a combination drawing showing a fourth preferred embodiment of the present invention;

FIG. 11 is a profile showing a stove element before catching fire;

FIG. 12 is a profile showing a position frame transporting a stove element after catching fire;

FIG. 13 is a partial breakdown drawing showing a fifth embodiment of the present invention.

### DETAILED DESCRIPTION OF THE PREFERRED EMBODIMENTS

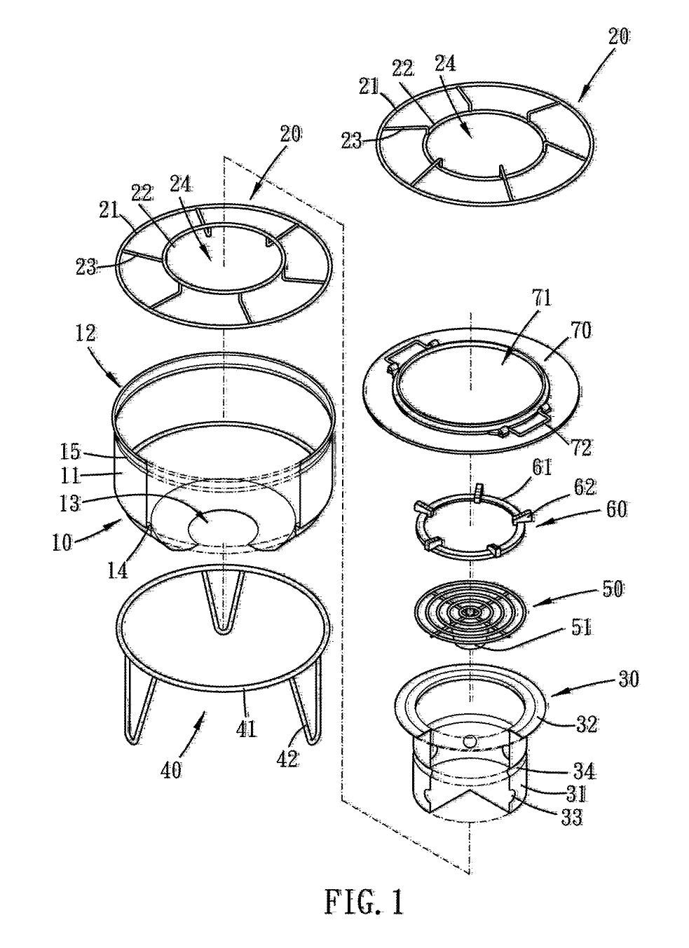

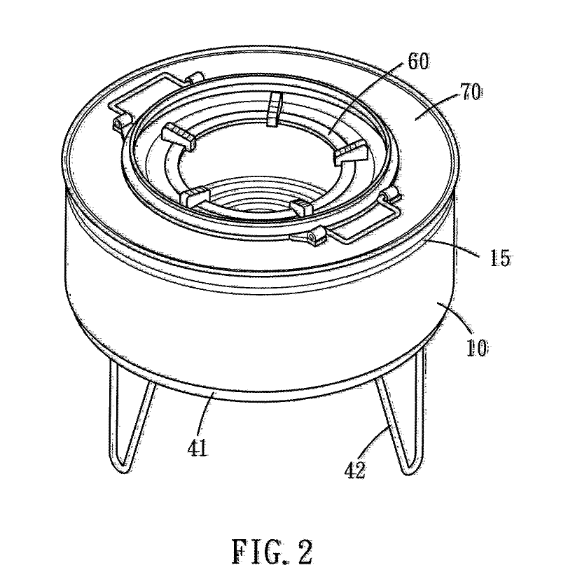

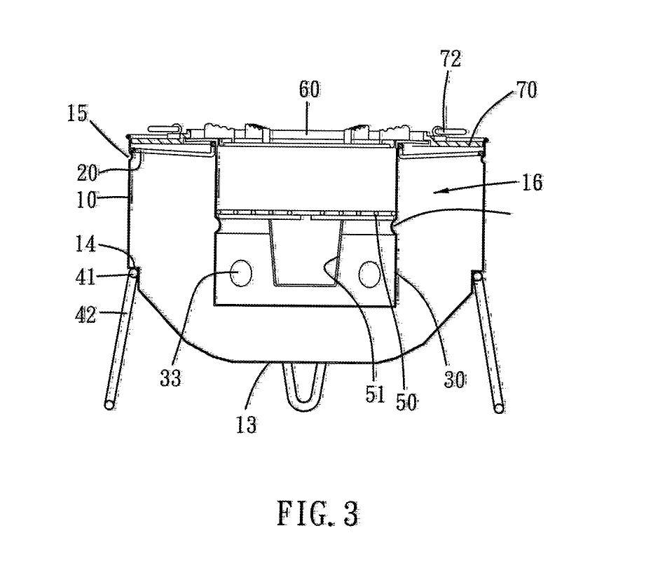

Please refer to FIG. 1 to FIG. 3 for a first embodiment of the present invention. The multi-functional cooking stove includes a stove body 10, a position frame 20, a stove element 30, a base 40, a coal frame 50, a stove rack 60 and an annular cover plate 70.

The stove body 10 has an annular shell 11 which defines an upper opening 12 and a lower opening 13. The lower opening 13 is smaller than the upper opening 12. The stove body 10 has a lower portion being tapered such that the air flow rate accelerates as the air enters the stove body 10 of bigger cross section via the lower opening 13 of smaller cross section. In addition, a negative pressure of the stove body 10 will draw the air into the stove body 10 to promote its air circulation. In the present embodiment, the tapered lower portion and the vertical upper portion of the stove body 10 is integrally formed, yet they can be separately formed and combined together with fixation means.

The base 40 is adapted for the stove body 10 to dispose thereon. Preferably, the base 40 has a displacement portion 41 corresponding to the contour of the stove body 10 and several supportive portions 42, and the stove body 10 has, on the other hand, a stepped outer engaging section 14 to engage with the displacement portion 41.

The position frame 20 is disposed in the stove body 10 at a predetermined height. Preferably, the position frame 20 has an outer position ring 21 and an inner position ring 22, which are bridged by a plurality of ribs 23. The outer position ring 21 is adapted to mount in the stove body 10, especially on an inner engaging section 15 of the stove body 10. The inner engaging section 15 can be integrally formed in the manner of rolling or pressing, or it can also be formed by welding additional shanks on the inner surface of the stove body 10 for the outer position ring 21 to mount thereon. Moreover, the inner position ring 22 defines a through hole 24 for a container body 31 of the stove element 30 to pass therethrough such that the stove element 30 can be hung on the position frame 20. More specifically, the container body 31 has an upper opening, and the stove element 30 has an annular flange 32 radially extending from an upper edge of the container body 31. The contour of the annular flange 32 exactly corresponds to that of the inner position ring 22 so that the annular flange 32 can mount on the ring 22. Furthermore, each rib 23 has an inclined section and a vertical section. The inclined section radially extends inward and downward from the outer position ring 21, and the vertical section axially extends downward from the inner position ring 22. The inclined section and the vertical section connect to each other and form a turn. A height of the turn is lower than that of the outer position ring 22, and a height of the inner position ring 21 is higher than that of the outer position ring 22. A height drop between the outer position ring 21 and the turn is substantially equal to that between the inner and outer position rings 22 and 21. As such, the user can installed the position frame 20 in the stove body 10 with either side up, e.g. the turns of the position frame may face upward for the annular flange 32 of the stove element 30 to be hung thereon, yet the height drop between the annular flange 32 and the outer position ring 21 remains unchanged.

That is to say, the stove element 20 of the present invention is hung on the position frame 20, and the position frame 20 is then mount in the stove body 10, thus defining a convection space 16 between the stove body 10 and the stove element 30. At least one convection bore 33 is disposed on a periphery of the container body 31. The convection bore 33 is preferably disposed near the bottom of the container body 31, and it communicates the convection space 16 with an interior of the container body 31. The stove element 30 is adapted for the heat source to dispose therein. More specifically, the coal frame 50 is disposed in the stove element 30, e.g. the coal frame 50 may mount on an engaging portion 34 of the stove element 30 as shown in FIG. 1. The engaging portion 34 may be integrally formed in the manner of rolling or pressing, or it may be formed by welding additional shanks. A cup 51 may be disposed beneath the coal frame 50, in which the coal frame 50 is adapted for solid fuel such as charcoal, coconut carbon, thermatomic carbon and etc. to dispose thereon, and the cup 51 is adapter for liquid fuel such as alcohol gel or solid fuel such as tinder or other fire lighter to dispose therein. Preferably, the height of the coal frame 50 is at least higher than the convection bore 33 with the lowest height (in the case that there are several convection bores with different heights).

The stove rack 60 is disposed on an upper end of the container body 31. More specifically, the stove rack 60 has an annular rim 61 corresponding to the annular flange 32 and several stands 62 spaced disposed on the annular rim 61. The annular rim 61 is disposed on the annular flange 32, and the stands 62 are adapted for a kettle, a pot, a cooking plate or etc. to dispose thereon.

The cover plate 70 is annularly formed and envelops the convection space 16, and the cover plate 70 defines a plate opening 71 at its center to communicate with the interior of the container body 31 of the stove element 30. For transportation purpose, two opposite grip portions 72 may be disposed on an upper surface of the cover plate 70 for the user to grip. The grip portions 72 are preferably U-shaped with two ends thereof pivoting on the upper surface of the cover plate 70.

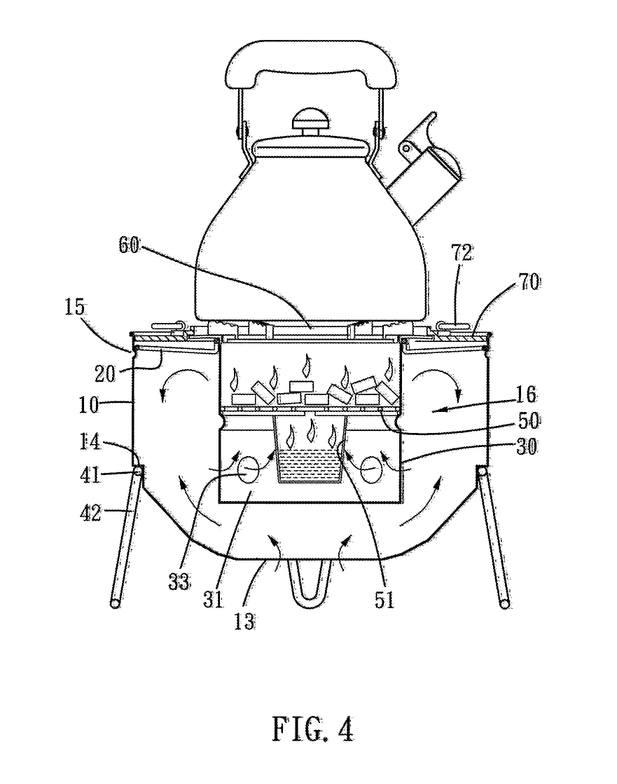

Please refer to FIG. 4. When the cooking stove is at use, the heat is mainly provided by the combustion of the solid fuel, such as charcoal or coconut carbon, disposed on the coal frame 50. The air flows into the convection space 16 via the bottom opening 13 and then enters the interior of the container body 31 via the convection bores 33 to supply the fire. Because the cooking stove of the present invention is direct-heating type, i.e. the fuel locates right beneath the object to be heated, such as the kettle and the water in the kettle, and further because the convection space 16 is enclosed by the cover plate 70, most of the heat energy has no other way but goes to the upper opening of the container body 31 to heat the kettle. In this case, the heat energy is centered to provide sufficient heat for user to sauté or to boil the water. Of course, the amount of heat energy may be adjusted by varying the amount and/or the density of the fuel, or by varying the air inlet flow rate of the bottom opening 13 when the user needs gentler heat for frying or stewing.

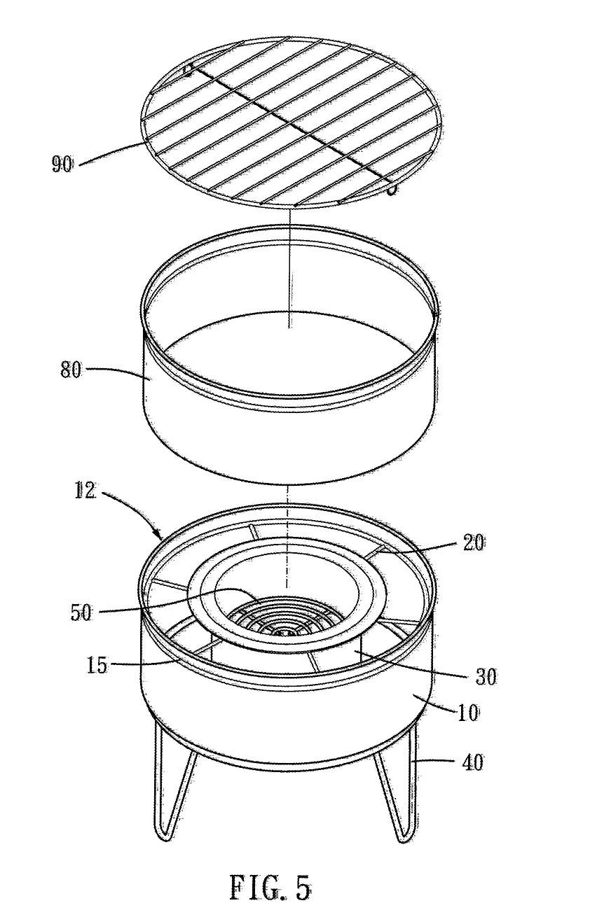

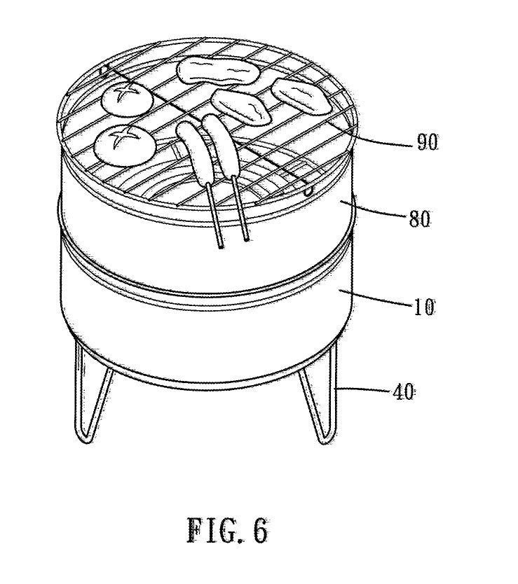

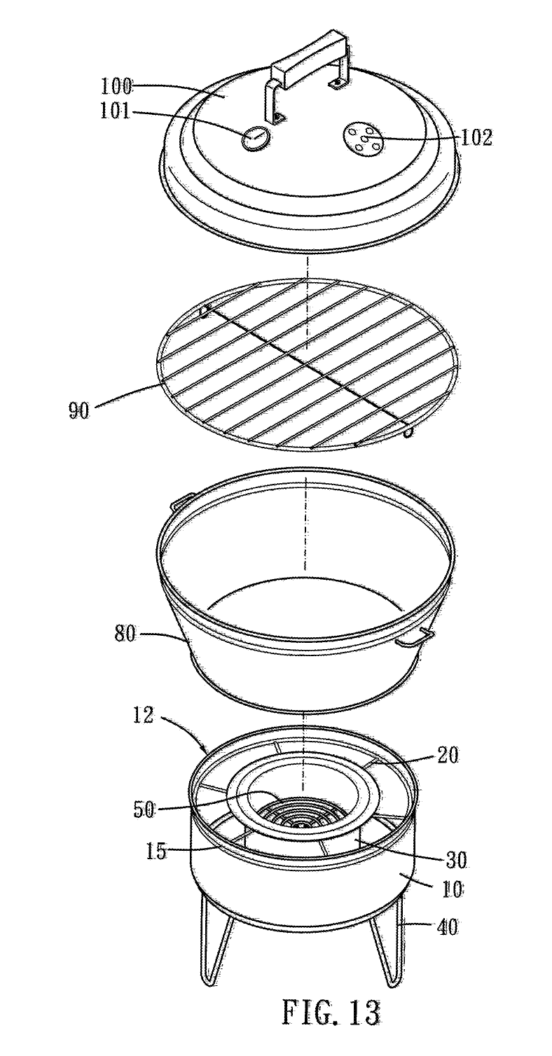

Please refer to FIG. 5 and FIG. 6 for the second embodiment of the present invention. The cooking stove of the present embodiment also includes the stove body 10, the position frame 20, the stove element 30, the base 40 and the coal frame 50, and it further includes an annular extender 80 which is disposed on the stove body 10 and corresponds to the upper opening 12 to increase the height of the cooking stove for the uniform convection of the heated air. A grill 90 can be disposed atop the annular extender 80 to broil food, and the annular extender 80 may taper off to a bottom thereof as shown in FIG. 13 in order to get an enlarged broiling area.

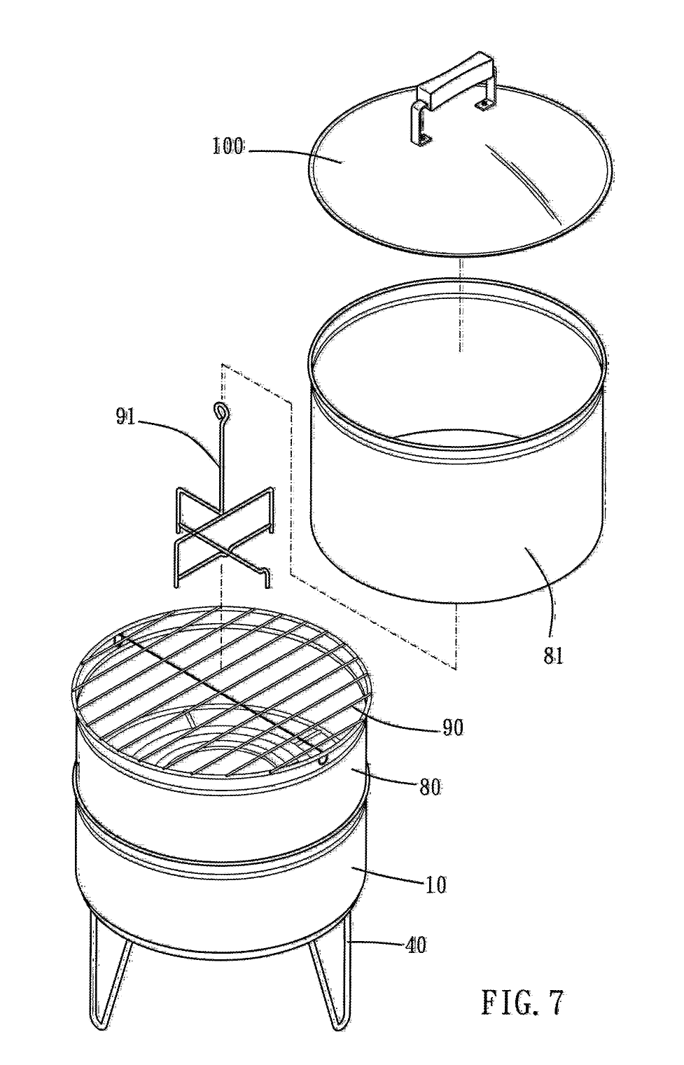

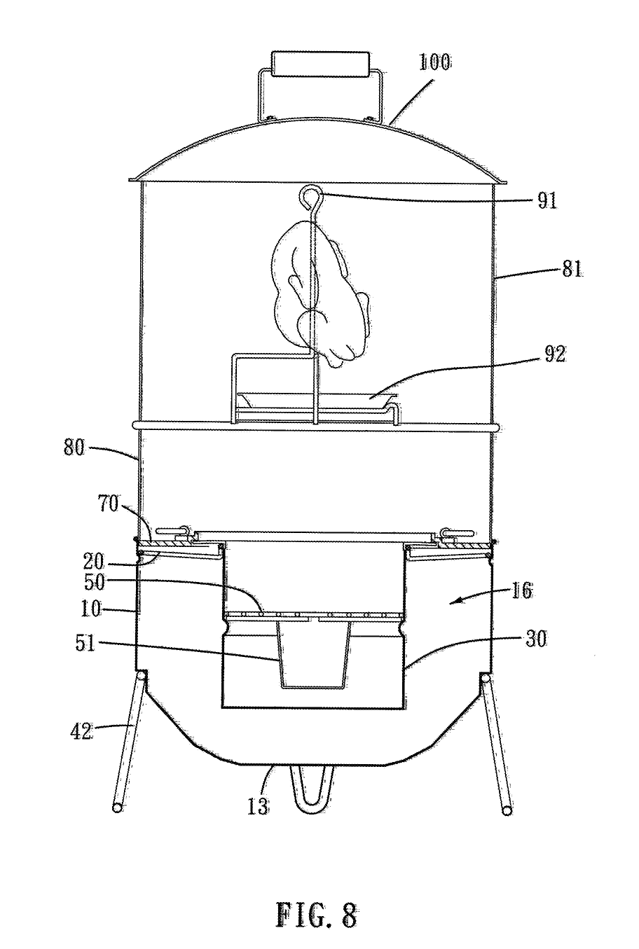

Please refer to FIG. 7 and FIG. 8 for the third embodiment of the present invention. Similar to the cooking stoves of the first and second embodiments, the stove of the present embodiment includes the stove body 10, the position frame 20, the stove element 30, the base 40, the coal frame 50, the cover plate 70, the annular extender 80 and the grill 90, yet it further includes an auxiliary extender 81 disposed on the extender 80 and a roasting rack 91 disposed on the grill 90 for a chicken or the like to hung thereon. A dish 92 may be placed at the bottom of the roasting rack 91 to receive the grease of the chicken. A cover 100 envelops an upper opening of the extender 81 for the user to roast food. When the auxiliary extender 81 is not installed, the cover 100 can cover the extender 80 instead. And when the extender 80 is not installed, the cover 100 can directly envelop the upper opening 12 of the stove body 10 to define a rather airtight roasting space. Note that the cover 100 may have a thermometer 101 and a small bore 102 for the heated air to escape therefrom.

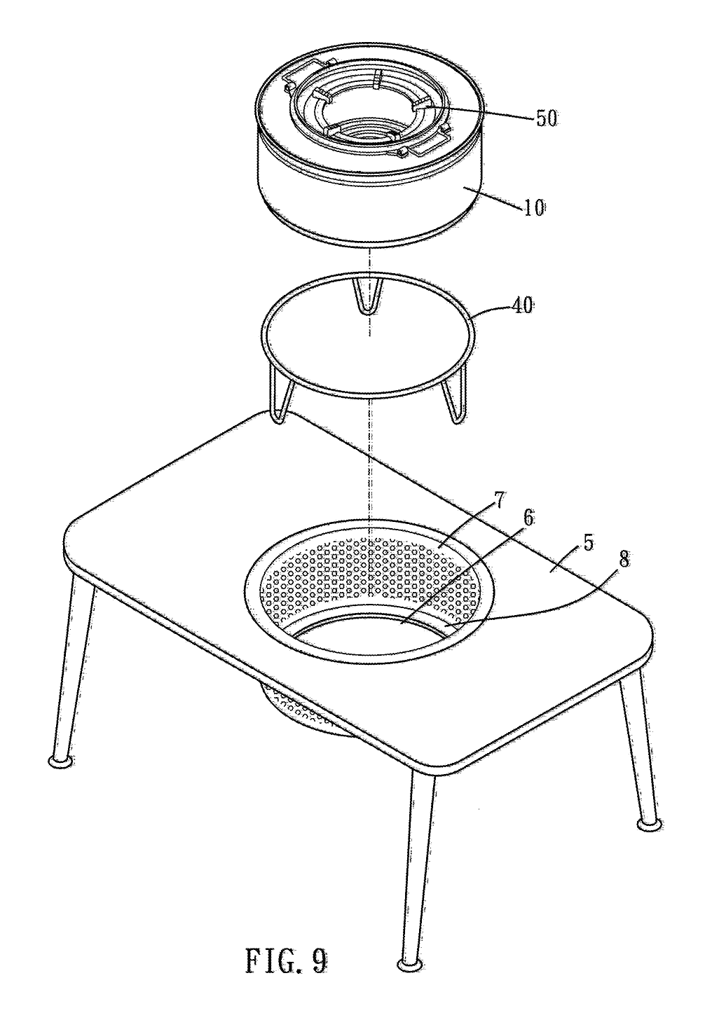

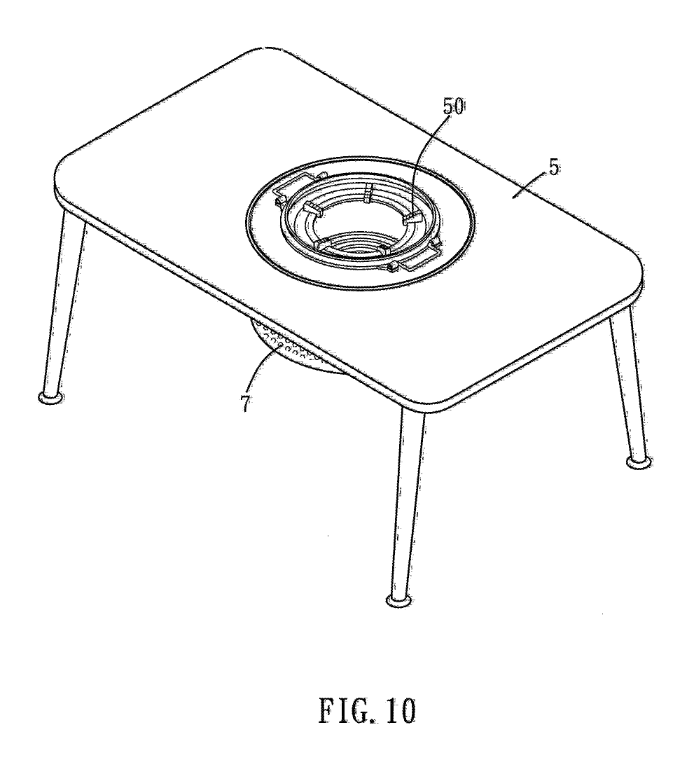

Further refer to FIG. 9 and FIG. 10 for the fourth embodiment of the present invention. The cooking stove of the present invention is installed on a table 5 which has a hole 6 and a shield 7 annularly disposed under the hole 6. An engaging rim 8 extends inward from a bottom edge of the shield 7 for the base 40 to mount thereon, so as to install the cooking stove on the table 5 with the stove rack 60 substantially flushing with the table 5. In this case, many users can enjoy cooking at the same time, and the shield 7 can prevent the user from accidentally touching the stove body and get scalded.

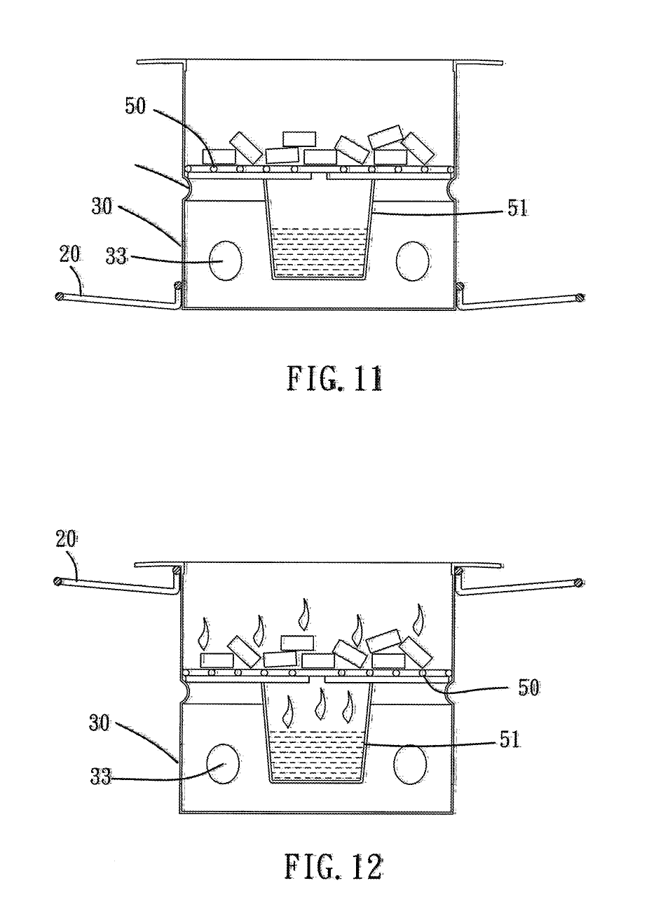

Please refer to FIG. 11. As the user catches fire, the stove element 30 can be taken out of the stove body 10, and the user can fill the cup 51 with alcohol gel or tinder to accelerate the fire catching procedure. Thereafter, the user simply moves the stove element 30 by lifting the position frame 20, as shown in FIG. 12, and installs the stove element 30 in the stove body 10 easily and quickly.

In summarization, the cooking stove of the present invention is multi-functional and adapted for many cooking manners such as flying, boiling, stewing, sauteing, hot-potting, broiling and roasting. The combination of the stove element and the cover plate realizes the object to center the heat energy, such that the cooking stove can provide sufficient heat for sauteing and boiling water. In addition, the stove element is designed to be removable from the stove body, so that the user can catch fire more easily and quickly. With the position frame, the user can easily move the stove element even when the fire is lighted. In light of the foregoing, the cooking stove of the present invention is much superior to the conventional ones for these and other reasons.

What is claimed is:

1. A multi-functional cooking stove, comprising:
a stove body, having an annular shell which defines an upper opening and a lower opening, the lower opening being smaller than the upper opening;
a position frame, disposed in the stove body, the position frame defining a through hole at its center;
a stove element, having a container body for fuel to dispose therein, the container body passing through the thorough hole, and the stove element being hung on the position frame, a convection space being defined between the stove body and the stove element, at least one convection bore being disposed on a periphery of the container body, the convection bore communicating the convection space with an interior of the container body.

2. The cooking stove of claim 1, further comprising a coal frame for solid fuel to dispose thereon, the coal frame being disposed in the stove element and higher than the convection bore.

3. The cooking stove of claim 2, wherein a cup is disposed beneath the coal frame for liquid fuel or solid fuel to dispose therein.

4. The cooking stove of claim 1, wherein the stove body has a lower portion being tapered.

5. The cooking stove of claim 1, further comprising an annular cover plate disposed atop and enveloping the convection space, the cover plate defining a plate opening at its center, the plate opening communicating the interior of the container body.

6. The cooking stove of claim 5, wherein two opposite grip portions are disposed on an upper surface of the cover plate.

7. The cooking stove of claim 1, further comprising a base for the stove body to disposed thereon.

8. The cooking stove of claim 1, further comprising a stove rack disposed on an upper end of the container body.

9. The cooking stove of claim 1, further comprising an annular extender disposed on the stove body and mainly extending upward.

10. The cooking stove of claim 9, further comprising a grill disposed atop the annular extender.

11. The cooking stove of claim 9, further comprising a cover enveloping the annular extender.

12. The cooking stove of claim 1, further comprising a cover enveloping the upper opening of the stove body.

13. The cooking stove of claim 1, wherein the position frame has an outer position ring and an inner position ring, a plurality of ribs bridge between the outer and inner position rings, the inner position ring defines the through hole.

14. The cooking stove of claim 13, wherein each rib has an inclined section and a vertical section, the inclined section radially extends inward and downward from the outer position ring, the vertical section axially extends downward from the inner position ring, the inclined section and the vertical section connect to each other and form a turn, a height of the turn is lower than that of the outer position ring, and a height of the inner position ring is higher than that of the outer positioning ring, a height drop between the outer position ring and the turn is substantially equal to that between the inner position ring and the outer position ring.

15. The cooking stove of claim 9, wherein the annular extender tapers off to a bottom thereof.
